(19) United States
(12) Patent Application Publication
(10) Pub. No.: US 2025/0340233 A1
(43) Pub. Date: Nov. 6, 2025

(54) UTILITIES SUPPORT SYSTEMS AND METHODS

(71) Applicant: THE BOEING COMPANY, Arlington, VA (US)

(72) Inventors: Alexandru Gheorghe Badger, Stanwood, WA (US); Allen Richard Link, Snohomish, WA (US)

(73) Assignee: THE BOEING COMPANY, Arlington, VA (US)

(21) Appl. No.: 18/655,632

(22) Filed: May 6, 2024

(51) Int. Cl. B62B 1/26; B60B 33/00

(52) U.S. Cl. CPC B62B 1/262; B60B 33/0002; B62B 2202/02

(57) ABSTRACT

A utilities support system is configured to support one or more utilities. The utilities support system includes a base, one or more caster assemblies extending downwardly from the base, an upright beam extending upwardly from the base, and utilities retainers extending from the upright beam. Each of the utilities retainers defines a retaining channel configured to retain one or more portions of the one or more utilities. One or more of the utilities retainers are upwardly angled in relation to the base.

### FIELD OF THE DISCLOSURE

Examples of the present disclosure generally relate to utilities support systems and methods, such as can be used to provide various utilities (for example, electrical cables, pneumatic tubes or cables, hydraulic tubes or cables, communications cables, and the like) during a manufacturing process, such as for a commercial aircraft.

### BACKGROUND OF THE DISCLOSURE

Various types of aircraft include numerous systems, components, devices, and the like. During a manufacturing process, various types of utilities are conveyed between manufacturing systems and portions of the aircraft being manufactured. For example, electrical cables, water supply lines, water return lines, pneumatic tubing, communications cables, and the like are used during the manufacturing process of the aircraft. As can be appreciated, the presence of the various utilities used during the manufacturing process can be obtrusive and often complex. As such, certain support structures are used to convey the various utilities between different locations.

However, known support structures may not allow for easy maintenance of certain utilities. Certain utilities may no longer be useful, but cannot be removed from a support structure without significant delays. Further, costly, single-use tooling may be required to remove the utilities form the support structure. Additionally, certain support structure may not have sufficient strength to support the loads of certain types and numbers of cables.

### SUMMARY OF THE DISCLOSURE

A need exists for an effective and efficient utilities support system, such as can be used during the manufacture of a commercial aircraft. Further, a need exists for a strong and robust utilities support system that is readily serviceable, and allows for efficient maintenance of utilities.

With those needs in mind, certain examples of the present disclosure provide a utilities support system configured to support one or more utilities. The utilities support system includes a base, one or more caster assemblies extending downwardly from the base, an upright beam extending upwardly from the base, and utilities retainers extending from the upright beam. Each of the utilities retainers defines a retaining channel configured to retain one or more portions of the one or more utilities. One or more of the utilities retainers are upwardly angled in relation to the base.

In at least one example, a first caster assembly extends downwardly from a first end of the base, and a second caster assembly extends downwardly from a second end of the base. The first end is opposite from the second end.

The utilities support system can further include a support bracket extending downwardly from the base.

The utilities support system can further include a bracing fin extending from the upright beam opposite from the utilities retainers. As a further example, the bracing fin connects to a support pad secured to the base.

In at least one example, the utilities retainers include a bed, and a back connected to the bed. The retaining channel is defined, at least in part, between the bed and the back. In at least one example, the back is curved (for example, C-shaped). The bed can include a plurality of parallel extension beams. In at least one example, the bed is upwardly angled. For example, the bed is upwardly angled between 3-25 degrees in relation to a longitudinal plane of the base. As a further example, the angle is approximately 5 degrees.

In at least one example, one or more of the utilities retainers includes a retaining door configured to be selectively moved between a closed position, in which the retaining channel is closed, and an open position, in which the retaining channel is opened. The retaining door can be formed of polyoxymethylene.

In at least one example, one or more of the utilities retainers include one or more liners. The one or more liners can include a slot. The one or more liners can be formed of polyoxymethylene.

In at least one example, the base includes one or more mounting channels configured to receive and retain portions of tie rods, which are configured to couple the utilities support system to one or more other utilities support systems.

The utilities support system can also include one or more protective covering shrouds extending over one or more portions of the one or more caster assemblies.

The utilities support system can also include end caps that are configured to be selectively secured to and removed from the utilities retainers.

### BRIEF DESCRIPTION OF THE DRAWINGS

FIG. 1 illustrates an isometric top rear view of a utilities support system, according to an example of the present disclosure.

FIG. 2 illustrates a lateral view of the utilities support system of FIG. 1.

FIG. 3 illustrates an isometric front view of a retaining door pivotally coupled to a utilities retainer, according to an example of the present disclosure.

FIG. 4 illustrates an isometric top rear view of a utilities support system, according to an example of the present disclosure.

FIG. 5 illustrates a top view of utilities support systems coupled together with tie rods, according to an example of the present disclosure.

FIG. 6 illustrates a lateral view of a utilities support system, according to an example of the present disclosure.

FIG. 7 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide a utilities support system, which can be used to support various utilities during a manufacturing process, such as of a commercial aircraft. The utilities support system is configured to support various utilities during the manufacturing process. Non-limiting examples of the utilities include electrical cables, electrical wires, hydraulic supply tubes, hydraulic return tubes, pneumatic tubes, communications cables, and the like. In at least one example, the utilities support system provides a mobile cable management system configured to provide support to numerous utilities between different locations.

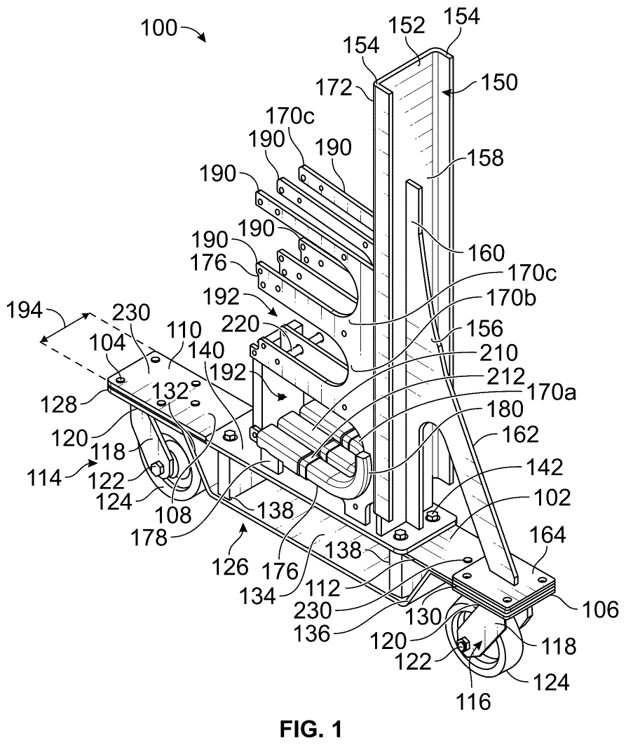

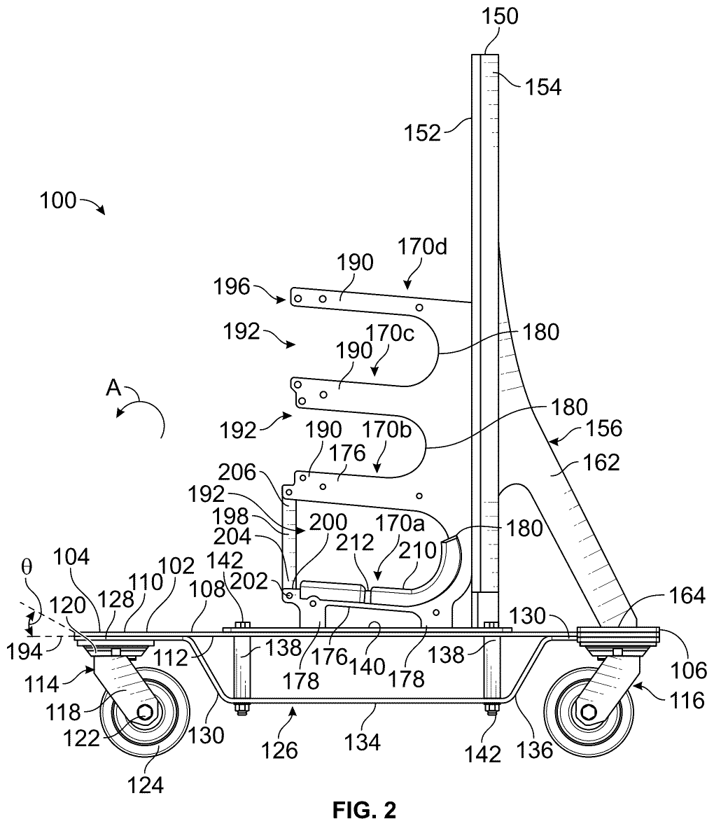

FIG. 1 illustrates an isometric top rear view of a utilities support system 100, according to an example of the present disclosure. FIG. 2 illustrates a lateral view of the utilities support system 100 of FIG. 1. Referring to FIGS. 1 and 2, the utilities support system 100 includes a base 102, which can be or otherwise include a flat panel having a first end 104 connected to a second end 106 (opposite from the first end 104) through a longitudinal main body 108. The base 102 has a first surface 110 (such as an upper surface) opposite from a second surface 112 (such as a lower surface).

A first caster assembly 114 is secured to, and extends downwardly from, the second surface 112 at or proximate to (such as within 6 inches or less) the first end 104. A second caster assembly 116 is secured to, and extends downwardly from, the second surface 112 at or proximate to (such as within 6 inches or less) the second end 106. The first caster assembly 114 and the second caster assembly 116 provide mobility, allowing the utilities support system 100 to be rolled and moved to desired positions.

The first caster assembly 114 and the second caster assembly 116 include brackets 118 extending downwardly from a pivot coupling 120, which allows for pivotal rotation. The brackets 118 connect to an axle 122 that extends through a wheel 124. The utilities support system 100 can include more caster assemblies than shown. For example, the utilities support system 100 can include a separate caster assembly located at each corner of the base 102. As another example, the utilities support system 100 can include two rear caster assemblies, and a single front caster assembly. As another example, the utilities support system 100 can include two front caster assemblies, and a single rear caster assembly. As another example, instead of caster assemblies, wheels can be fixed to the base 102, and rotationally coupled thereto through axles. Alternatively, the utilities support system 100 may not include casters or wheels.

A support bracket 126 extends downwardly from the second surface 112 of the base 102 between the first caster assembly 114 and the second caster assembly 116. The support bracket 126 can include a flat first flange 128 secured between the first caster assembly 114 and the second surface 112 of the base 102, and a flat second flange 130 secured between the second caster assembly 116 and the second surface 112 of the base 102. The first flange 128 connects to a first angled wall 132, which connects to a lower wall 134, which is parallel to, and spaced apart from, the base 102. The lower wall 134, in turn, connects to a second angled 136, which connects to the second flange 130. Bracing tubes 138 span between the lower wall 134 and the base 102. A support plate 140 can overlay a portion of the first surface 110 of the base 102. Fasteners 142 (such as bolts) extend through the support plate 140, the base 102, the bracing tubes 138, and the lower wall 134, thereby providing a secure, bracing connection between the support bracket 126 and the base 102. Optionally, the utilities support system 100 may not include the support bracket 126.

An upright beam 150 extends upwardly from the base 102 (and/or the support plate 140. The upright beam 150 includes a flat main panel 152, and rearwardly canted lateral edges 154, which provide increased strength and resilience. The upright beam 150 can extend perpendicularly upward in relation to the base 102.

In at least one example, a bracing fin 156 extends rearwardly from a rear surface 158 of the main panel 152 of the upright beam 150. The bracing fin 156 includes an upright panel 160 that perpendicularly extends from the rear surface 158, and an angled branch 162, which angles away from the upright panel 160, and connects to a support pad 164 over the second end 106 of the base 102. The bracing fin 156 provides bracing support and strength to the upright beam 150. Optionally, the utilities support system 100 may not include the bracing fin 156.

The utilities support system 100 includes a plurality of utilities retainers 170 extending from a front surface 172 of the upright beam 150. The utilities retainers 170 extend forwardly from the main panel 152 opposite from (for example, in an opposite direction) the bracing fin 156. A lower utilities retainer 170a includes a bed 176 having supports 178 (such as blocks, studs, posts, or the like) that connect to the base 102 and/or the support plate 140. The bed 176 connects to a back 180, which is curved and arcuate. In at least one example, the back 180 is C-shaped. The back 180 connects to a bed 176 of a utilities retainer 170b above the utilities retainer 170a. Similarly, a utilities retainer 170c can be disposed over the utilities retainer 170b. A flat utilities retainer 170d can be disposed over the utilities retainer 170c. The utilities support system 100 can include more or fewer utilities retainers 170 than shown.

The beds 176 of the utilities retainers 170 include parallel extension beams 190, such as planar fins. As shown, the beds 176 can include three parallel extension beams 190. The spaced apart extension beams 190 utilize less material than a flat pan, for example, thereby reducing overall cost. In at least one example, the extension beams 190 of a utilities retainer 170 can be secured together through one or more fasteners 220, such as one or more bolts and nuts. Optionally, the beds can include more or fewer extension beams 190. As another example, instead of parallel extension beams 190, the beds 176 can include contiguous plates, pans, or the like.

Each bed 176 and respective back 180 forms, at least in part, a retaining channel 192, configured to retain at least a portion of one or more utilities (such as electrical cables, pneumatic tubes, hydraulic lines, communication cables, and/or the like). The retaining channel 192 can be defined by a lower bed 176 of a first utilities retainer 170, a back 180, and an upper bed 176 of a second utilities retainer 170 directly above the first utilities retainer 170.

The utilities retainers 170 extend forwardly from the upright beam 150. In at least one example, the utilities retainers 170 are upwardly angled. For example, the utilities retainers 170 are upwardly angled in relation to a longitudinal plane 194 of the base 102. The beds 176 are disposed at an angle Θ in relation to the longitudinal plane 194 of the base 102. In at least one example, angle Θ is between 3-25 degrees. For example, the angle Θ can be approximately 5 degrees (such as between 4.75-5.25 degrees). The upward angle of the utilities retainers 170 aids in retaining utilities within the retaining channels 192. That is, by upwardly angling the utilities retainers 170, the utilities are unlikely to fall forwardly out of the retaining channels 192. Alternatively, the utilities retainers 170 may not be upwardly angled. Instead, the beds 176 can be parallel with a plane of the base 102.

As shown, at least some of the utilities retainers 170 can include an open forward end 196, which allows for insertion of portions of the utilities into the retaining channels 192. In at least one example, all of the utilities retainers 170 can include open forward ends 196.

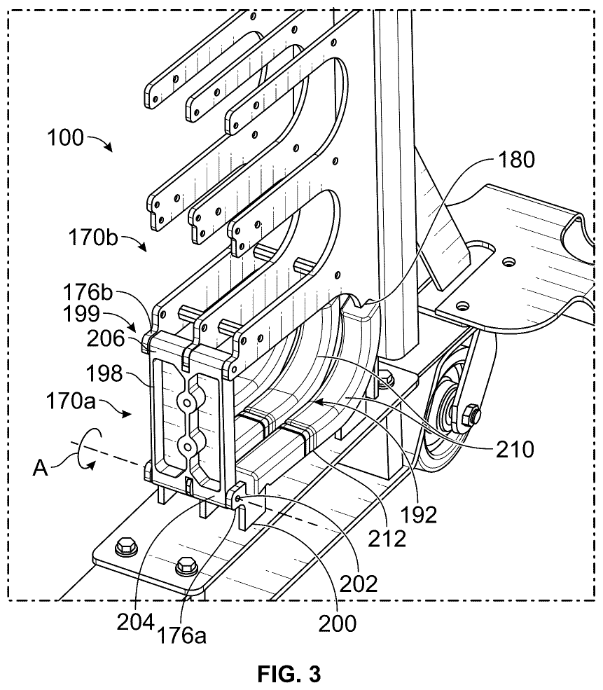

FIG. 3 illustrates an isometric front view of a retaining door 198 pivotally coupled to the utilities retainer 170a, according to an example of the present disclosure. In at least one example, one or more of the utilities retainers 170 include a retaining door 198 at a forward end 199. The retaining door 198 pivotally couples to a bed 176. For example, the retaining door 198 pivotally couples to a forward end 200 of a lower bed 176a via a pivot axle 202. As such, a bottom 204 of the retaining door 198 pivotally couples to the lower bed 176a, while a top 206 of the retaining door 198 is configured to open and close in relation to an upper bed 176b (of the utilities retainer 170). Optionally, the retaining door 198 can be configured to be pivotally coupled to the upper bed 176b.

The retaining door 198 is configured to be moved between an open position, to allow for access into the retaining channel 192, and a closed position, which closes the retaining channel 192. Thus, in order to remove utilities within a retaining channel 192, the retaining door 198 is pivoted open about the pivot axle 202 in the direction of arrow A, thereby opening the retaining channel 192. The utilities can then be removed, and replacement utilities can be disposed therein. The retaining door 198 is then pivoted in an opposite direction to securely retain the replacement utilities within the retaining channel 192. In at least one example, the retaining door 198 can be spring-biased toward a closed position. In at least one example, the free end of the retaining door 198 (opposite from the pivot axle 202) can latch onto a portion of the bed 176b to secure the retaining door 198 in the closed position.

In at least one example, the retaining door 198 is formed of a stiff, low-friction thermoplastic, such as polyoxymethylene (acetal or polyacetal), which provides a stiff, low friction material, that is well suited for supporting utilities. As shown, the lower utilities retainer 170a include the retaining door 198. Optionally, one or more other utilities retainers 170b, 170c, and/or 170d can include a retaining door 198. In at least one example, each of the utilities retainers 170 includes a retaining door.

Referring to FIGS. 1-3, in at least one example, one or more of the utilities retainers 170 includes a liner 210 overlaying at least a portion of the bed 176 and the back 180. The liners 210 can fit over the bed 176 and/or the back 180 through one or more adhesives, or an interference fit, for example. The liners 210 may be devoid of fasteners, in order to reduce snagging portions of utilities. A slot 212 can be formed in the liners 210. The slot 212 is configured to receive and retain straps, ties, or the like, to secure portions of the utilities thereto. Optionally, the liners 210 may not include the slots 212.

In at least one example, the liners 210 are formed of the stiff, low-friction thermoplastic, such as polyoxymethylene (acetal or polyacetal), which provides a stiff, low friction material, which is well suited for supporting utilities. The liners 210 can have a thickness between 0.10 inches to 0.50 inches. In at least one example, the liners 210 have a thickness of 0.25 inches. As shown, the utilities retainer 170a includes three curved liners 210. Each liner 210 is disposed on an extension beam of the bed 176 and/or the back 180. The liners 210 can be separate and distinct from one another (as larger pieces can be susceptible to a higher failure rate).

As shown, the lower utilities retainer 170a includes the liners 210. Optionally or additionally, one or more of the other retainers 170b-d can include the liners 210. Alternatively, none of the utilities retainers 170 include liners.

Various portions of the utilities support system 100 are formed of metal, such as steel. For example, the base 102, the upright beam 150, the support bracket 126, and the support plate 140 are formed of steel, and can be secured together through welding, fasteners, and/or the like.

In at least one example, the base 102 includes mounting channels 230, such as proximate to the first end 104 and the second end 106. The mounting channels 230 can be holes configured to receive and retain portions of tie rods, which are configured to couple the utilities support system 100 to another utilities support system 100.

As described herein, the utilities support system 100 is configured to support one or more utilities. In at least one example, the utilities support system includes the base 102, one or more caster assemblies 114 and/or 116 extending downwardly from the base 102. The upright beam 150 extends upwardly from the base 102. Utilities retainers 170 extend forwardly from the upright beam 150. Each of the utilities retainers 170 defines a retaining channel 192 configured to retain one or more portions of the one or more utilities. The utilities retainers 170 are upwardly angled in relation to the base 102. In at least one example, one or more of the utilities retainers 170 includes a retaining door 198 configured to be selectively moved between a closed position, in which the retaining channel 192 is closed, and an open position, in which the retaining channel 192 is opened.

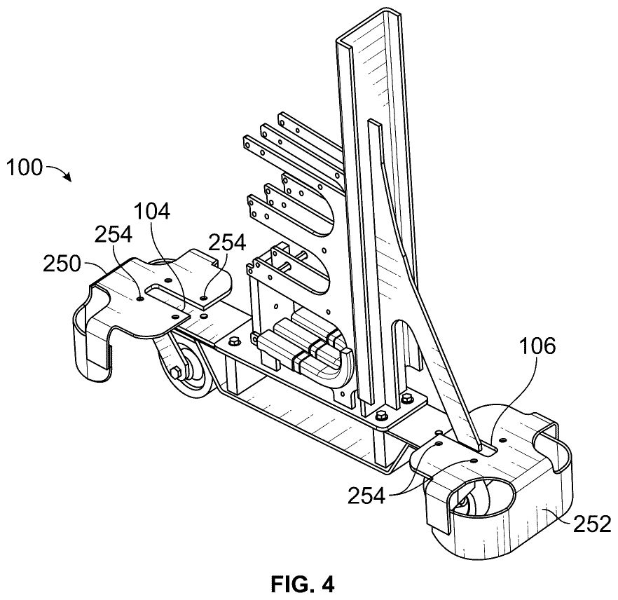

FIG. 4 illustrates an isometric top rear view of the utilities support system 100, according to an example of the present disclosure. The utilities support system 100 can include a protective covering shroud 250 extending over, forward, and/or to sides of the first end 104, and/or a protective covering shroud 252 extending over, rearward and/or to sides of the second end 106. The covering shrouds 250 and 252 prevent inadvertent contact with the caster assemblies 114 and 116. The covering shrouds 250 and 252 can also include mounting channels 254 configured to receive and retain portions of tie rods, which are configured to couple the utilities support system 100 to another utilities support system 100. Optionally, the utilities support system 100 may not include the covering shrouds 250 and/or 252.

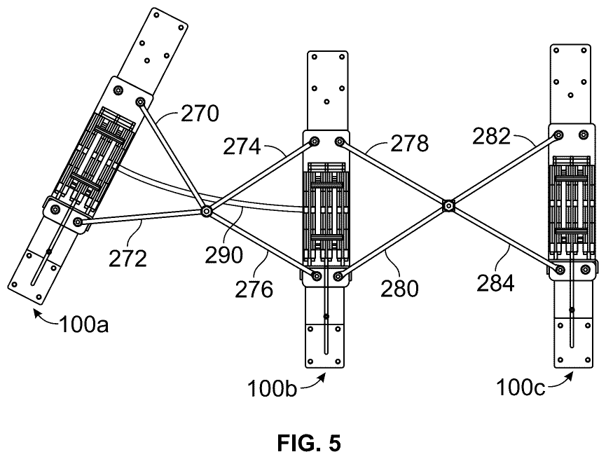

FIG. 5 illustrates a top view of utilities support systems 100a, 100b, and 100c coupled together with tie rods 270, 272, 274, 276, 278, 280, 282, and 284 according to an example of the present disclosure. The tied rods 270, 272, 274, 276, 278, 280, 282, and 284 have ends configured to be received and retained by or otherwise mounting channels of the utilities support systems 100a, 100b, and 100c. Numerous utilities support systems 100a, 100b, 100c, . . . 100n can be coupled together to provide a support infrastructure for various utilities 290 between different locations.

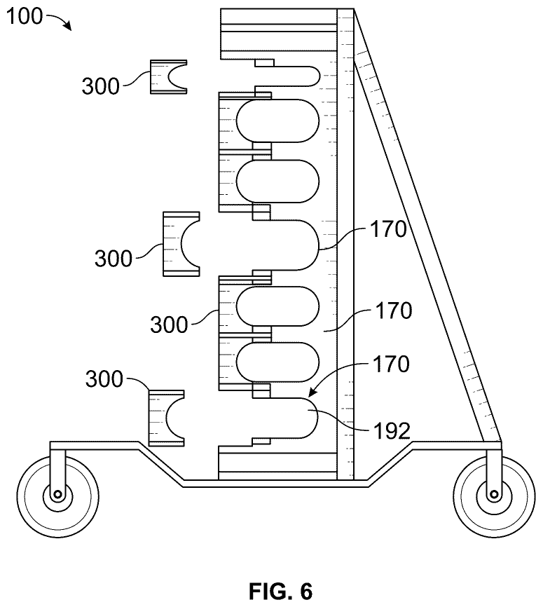

FIG. 6 illustrates a lateral view of a utilities support system 100, according to an example of the present disclosure. In at least one example, removable end caps 300 can be used to selectively open and close the retaining channels 192. The end cap 300 can be configured to plug into open ends of the utilities retainers 170. As another example, the end caps 300 can be configured to latch onto the utilities retainers 170. As another example, the end caps 300 can be configured to fit over portions of the utilities retainers 170. The end caps 300 can be used instead of (or in addition to) retaining doors. Optionally, the utilities support system 100 may not include removable end caps.

Referring to FIGS. 1-6, examples of the present disclosure provide utilities support systems 100 having a vertical support framework that includes a plurality of utilities retainers 170 defining retaining channels 192, each of which is configured to retain a portion of one or more utilities. One or more of the utilities retainers 170 include one or more liners 210. In at least one example, the utilities retainers 170 are upwardly angled (such as in relation to the longitudinal plane 194 of the base 102) approximately 5 degrees to ensure retention of the portions of the utilities. Additionally, one or more of the utilities retainers 170 includes a retaining door 198 configured to close an open end, such that the utilities retained therein can be individually accessed for service (such as by opening the retaining door 198) without affecting utilities retained by other utilities retainers 170. The utilities support systems 100 described herein allow for efficient maintenance and service of utilities without compromising structural integrity. Additionally, examples of the present disclosure allow for removal of utilities without the need for special tooling.

The utilities support systems 100 described herein can be used to supply various utilities in their own specified capacities to a location, such as an aircraft spine-tool (which is an end affecting tool). The utilities support systems 100 provide a support infrastructure between a facility utility vault and an aircraft utility vault, for example.

The utilities support systems 100 described herein are configured to house, carry, and protect utilities from strain, damage, and excessive wear. Further, due to the caster assemblies, the utilities support systems 100 are mobile, portable, and relatively easy to move on a factory floor. Also, the utilities support systems 100 allow for quick, efficient, and effective maintenance of utilities retained therein, without the need for special tools.

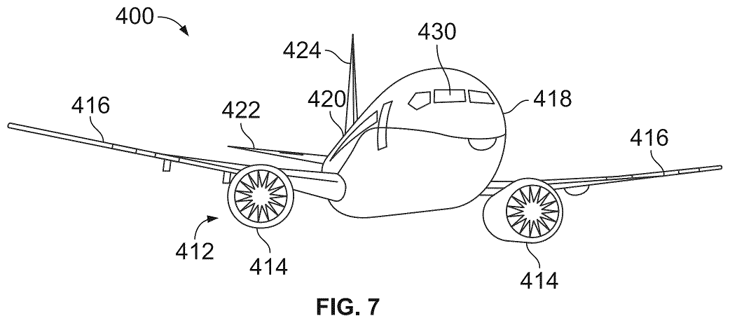

FIG. 7 illustrates a perspective front view of an aircraft 400, according to an example of the present disclosure. Referring to FIGS. 1-7, one or more utilities support systems 100 are used to support various utilities used during a manufacturing process of the aircraft 400.

The aircraft 400 includes a propulsion system 412 that includes engines 414, for example. Optionally, the propulsion system 412 may include more engines 414 than shown. The engines 414 are carried by wings 416 of the aircraft 400. In other examples, the engines 414 may be carried by a fuselage 418 and/or an empennage 420. The empennage 420 may also support horizontal stabilizers 422 and a vertical stabilizer 424. The fuselage 418 of the aircraft 400 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 7 shows an example of an aircraft 400. It is to be understood that the aircraft 400 can be sized, shaped, and configured differently than shown in FIG. 7.

The utilities support systems 100 can be used during the manufacture of various other vehicles (such as automobiles, buses, trains, seacraft, spacecraft, or the like). Further, the utilities support systems 100 can be used during production of fixed structures, such as commercial or residential buildings. Additionally, the utilities support systems 100 can be used to support and route utilities for various vehicles, systems, structures, and/or the like after manufacturing processes. As an example, the utilities support systems 100 can be used to support and route utilities within buildings, stadiums, and the like.

Further, the disclosure comprises examples according to the following clauses:
Clause 1. A utilities support system configured to support one or more utilities, the utilities support system comprising:
a base;
one or more caster assemblies extending downwardly from the base;
an upright beam extending upwardly from the base; and
utilities retainers extending from the upright beam, wherein each of the utilities retainers defines a retaining channel configured to retain one or more portions of the one or more utilities, wherein one or more of the utilities retainers are upwardly angled in relation to the base.
Clause 2. The utilities support system of Clause 1, wherein the one or more caster assemblies comprise:
a first caster assembly extending downwardly from a first end of the base; and
a second caster assembly extending downwardly from a second end of the base, wherein the first end is opposite from the second end.
Clause 3. The utilities support system of Clauses 1 or 2, further comprising a support bracket extending downwardly from the base.
Clause 4. The utilities support system of any of Clauses 1-3, further comprising a bracing fin extending from the upright beam opposite from the utilities retainers.
Clause 5. The utilities support system of Clause 4, wherein the bracing fin connects to a support pad secured to the base.
Clause 6. The utilities support system of any of Clauses 1-5, wherein the utilities retainers comprise:
a bed; and
a back connected to the bed,
wherein the retaining channel is defined, at least in part, between the bed and the back.
Clause 7. The utilities support system of Clause 6, wherein the back is curved.
Clause 8. The utilities support system of Clauses 6 or 7, wherein the bed comprises a plurality of parallel extension beams.
Clause 9. The utilities support system of any of Clauses 6-8, wherein the bed is upwardly angled.
Clause 10. The utilities support system of Clause 9, wherein the bed is upwardly angled between 3-25 degrees in relation to a longitudinal plane of the base.
Clause 11. The utilities support system of Clause 10, wherein the angle is approximately 5 degrees.
Clause 12. The utilities support system of any of Clauses 1-11, wherein one or more of the utilities retainers comprises a retaining door configured to be selectively moved between a closed position, in which the retaining channel is closed, and an open position, in which the retaining channel is opened.
Clause 13. The utilities support system of Clause 12, wherein the retaining door is formed of polyoxymethylene.
Clause 14. The utilities support system of any of Clauses 1-13, wherein one or more of the utilities retainers comprises one or more liners.
Clause 15. The utilities support system of Clause 14, wherein the one or more liners comprise a slot.
Clause 16. The utilities support system of Clauses 14 or 15, wherein the one or more liners are formed of polyoxymethylene.
Clause 17. The utilities support system of any of Clauses 1-16, wherein the base comprises one or more mounting channels configured to receive and retain portions of tie rods, which are configured to couple the utilities support system to one or more other utilities support systems.
Clause 18. The utilities support system of any of Clauses 1-17, further comprising one or more protective covering shrouds extending over one or more portions of the one or more caster assemblies.
Clause 19. The utilities support system of any of Clauses 1-18, further comprising end caps that are configured to be selectively secured to and removed from the utilities retainers.
Clause 20. A method for a utilities support system, the method comprising retaining one or more portions of one or more utilities within the retaining channel.
Clause 21. A utilities support system configured to support one or more utilities, the utilities support system comprising:
a base having a first end and a second end opposite from the first end, wherein the base includes one or more mounting channels configured to receive and retain portions of tie rods, which are configured to couple the utilities support system to one or more other utilities support systems;
a first caster assembly extending downwardly from the first end of the base;
a second caster assembly extending downwardly from the second end of the base;
a support bracket extending downwardly from the base between the first caster assembly and the second caster assembly;
an upright beam extending upwardly from the base;
a bracing fin extending from the upright beam, wherein the bracing fin connects to a support pad secured to the base; and
utilities retainers extending from the upright beam opposite from the bracing fin, wherein each of the utilities retainers defines a retaining channel configured to retain one or more portions of the one or more utilities, wherein the utilities retainers are upwardly angled in relation to the base, wherein the utilities retainers comprise:
   a bed including a plurality of parallel extension beams, wherein the bed is upwardly angled approximately 5 degrees in relation to a longitudinal plane of the base;
   a curved back connected to the bed, wherein the retaining channel is defined, at least in part, between the bed and the back;
   a retaining door configured to be selectively moved between a closed position, in which the retaining channel is closed, and an open position, in which the retaining channel is opened, wherein the retaining door is formed of polyoxymethylene; and
   one or more liners formed of polyoxymethylene, wherein the one or more liners comprise a slot.

As described herein, examples of the present disclosure provide effective and efficient utilities support system, such as can be used during the manufacture of a commercial aircraft. Further, examples of the present disclosure provide strong and robust utilities support systems that are readily serviceable, and allow for efficient maintenance of utilities.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A utilities support system configured to support one or more utilities, the utilities support system comprising:
a base;
one or more caster assemblies extending downwardly from the base;
an upright beam extending upwardly from the base; and
utilities retainers extending from the upright beam, wherein each of the utilities retainers defines a retaining channel configured to retain one or more portions of the one or more utilities, wherein one or more of the utilities retainers are upwardly angled in relation to the base.

2. The utilities support system of claim 1, wherein the one or more caster assemblies comprise:
a first caster assembly extending downwardly from a first end of the base; and
a second caster assembly extending downwardly from a second end of the base, wherein the first end is opposite from the second end.

3. The utilities support system of claim 1, further comprising a support bracket extending downwardly from the base.

4. The utilities support system of claim 1, further comprising a bracing fin extending from the upright beam opposite from the utilities retainers.

5. The utilities support system of claim 4, wherein the bracing fin connects to a support pad secured to the base.

6. The utilities support system of claim 1, wherein the utilities retainers comprise:
a bed; and
a back connected to the bed,
wherein the retaining channel is defined, at least in part, between the bed and the back.

7. The utilities support system of claim 6, wherein the back is curved.

8. The utilities support system of claim 6, wherein the bed comprises a plurality of parallel extension beams.

9. The utilities support system of claim 6, wherein the bed is upwardly angled.

10. The utilities support system of claim 9, wherein the bed is upwardly angled between 3-25 degrees in relation to a longitudinal plane of the base.

11. The utilities support system of claim 10, wherein the angle is approximately 5 degrees.

12. The utilities support system of claim 1, wherein one or more of the utilities retainers comprises a retaining door configured to be selectively moved between a closed position, in which the retaining channel is closed, and an open position, in which the retaining channel is opened.

13. The utilities support system of claim 12, wherein the retaining door is formed of polyoxymethylene.

14. The utilities support system of claim 1, wherein one or more of the utilities retainers comprises one or more liners.

15. The utilities support system of claim 14, wherein the one or more liners comprise a slot.

16. The utilities support system of claim 14, wherein the one or more liners are formed of polyoxymethylene.

17. The utilities support system of claim 1, wherein the base comprises one or more mounting channels configured to receive and retain portions of tie rods, which are configured to couple the utilities support system to one or more other utilities support systems.

18. The utilities support system of claim 1, further comprising one or more protective covering shrouds extending over one or more portions of the one or more caster assemblies.

19. The utilities support system of claim 1, further comprising end caps that are configured to be selectively secured to and removed from the utilities retainers.

20. A method for a utilities support system, the utilities support system comprising:
a base;
one or more caster assemblies extending downwardly from the base;
an upright beam extending upwardly from the base; and
utilities retainers extending from the upright beam, wherein each of the utilities retainers defines a retaining channel, wherein one or more of the utilities retainers are upwardly angled in relation to the base,
the method comprising:
retaining one or more portions of one or more utilities within the retaining channel.

21. A utilities support system configured to support one or more utilities, the utilities support system comprising:
a base having a first end and a second end opposite from the first end, wherein the base includes one or more mounting channels configured to receive and retain portions of tie rods, which are configured to couple the utilities support system to one or more other utilities support systems;
a first caster assembly extending downwardly from the first end of the base;
a second caster assembly extending downwardly from the second end of the base;
a support bracket extending downwardly from the base between the first caster assembly and the second caster assembly;
an upright beam extending upwardly from the base;
a bracing fin extending from the upright beam, wherein the bracing fin connects to a support pad secured to the base; and
utilities retainers extending from the upright beam opposite from the bracing fin, wherein each of the utilities retainers defines a retaining channel configured to retain one or more portions of the one or more utilities, wherein the utilities retainers are upwardly angled in relation to the base, wherein the utilities retainers comprise:
a bed including a plurality of parallel extension beams, wherein the bed is upwardly angled approximately 5 degrees in relation to a longitudinal plane of the base;
a curved back connected to the bed, wherein the retaining channel is defined, at least in part, between the bed and the back;
a retaining door configured to be selectively moved between a closed position, in which the retaining channel is closed, and an open position, in which the retaining channel is opened, wherein the retaining door is formed of polyoxymethylene; and
one or more liners formed of polyoxymethylene, wherein the one or more liners comprise a slot.
